(19) United States
(12) Patent Application Publication
(10) Pub. No.: US 2004/0067018 A1
(43) Pub. Date: Apr. 8, 2004

(54) Method of enhancing the photosensitivity of a material

(76) Inventors: John Canning, Carlton (AU); Pei-fang Hu, Eveleigh (AU)

Correspondence Address: Richard J Streit, Ladas & Parry, Suite 120, 224 South Michigan Avenue, Chicago, IL, 60604, US

(21) Appl. No.: 10/468,586

(22) PCT Filed: Feb. 26, 2002
(86) PCT No.: PCT/AU02/00200

(30) Foreign Application Priority Data
Feb. 26, 2001 (AU) PR3353

(51) Int. Cl. G02B 6/34

(52) U.S. Cl. 385/37

(57) ABSTRACT

A material such as an optical fibre is subjected to hydrogen loading. Substantially all the unreacted hydrogen is then allowed to diffuse out of the material. This procedure enhances the photosensitivity of the material, and the hydrogen loading is performed at a temperature and duration which avoids formation of hydroxyl species in the material (eg, 80 degrees Celsius for 14 days for a phosphosilicate fibre). An optical structure such as a Bragg grating (14) may subsequently be written in the material, via UV irradiation.

### FIELD OF THE INVENTION

The present invention relates broadly to a method of enhancing the photosensitivity of a photosensitive light transmissive material and to a method of creating an optical structure within a photosensitive light transmissive material. The present invention has applications in the creation of gratings and similar structures within optical waveguides, including in optical fibres, and the invention is hereinafter described in that context. However, it will be understood that the invention does have broader applications, including to the enhancement of the photosensitivity of various types of photosensitive light transmissive materials, and in various forms such as in planar form or in optical fibre form.

### BACKGROUND OF THE INVENTION

The creation of optical structures within photosensitive light transmissive materials, such as the writing of gratings in an optical fibre, is a significant process within optical technologies such as the technology of wavelength division multiplexing.

In the writing of gratings it is typically desirable to achieve high refractive index contrasts within a selected region of the optical fibre, the regions of different refractive index forming the optical grating structure.

Different techniques have been utilised to enhance the photosensitivity of optical fibres to facilitate subsequent formation of optical structures.

In one technique, the photosensitivity of an optical fibre is increased by exposing a region of the fibre to optical radiation until the fluence has reached a predetermined level, the fluence level being selected to render the exposed region of the fibre substantially thermally stable at temperatures up to 250° C. Gratings are then written into the fibre in the conventional way using UV radiation at a level sufficient to vary the refractive index of the material.

This technique may also include the step of hydrogen-loading the selected region prior to the initial exposure to radiation, and may also include the step of removing the loaded hydrogen by out-diffusion after the initial exposure to radiation.

However, this technique has a disadvantage in that it requires two steps of laser irradiation of the optical fibre in order to create relatively stable gratings.

An alternative technique for enhancing the photosensitivity of optical fibres is based on an assumption that the photosensitivity of an optical fibre is enhanced because of the presence of hydrides and/or hydroxyls in the material of the fibre. Following this assumption, techniques have been developed to increase the formation of hydrides and/or hydroxyls in the fibre. One such technique includes the steps of hydrogen-loading an optical fibre, and heating the fibre to very high temperatures of the order of 1000-1300° C. using an oven or CO₂ laser such that OH species are formed. A supposed correlation between OH formation and photosensitivity has been reported.

However, the presence of OH species produces undesirable optical attenuation and fibre brittleness in the resultant optical structure.

### SUMMARY OF THE INVENTION

Experiments by the applicant have indicated that the photosensitivity of silica-based optical fibres do not always correlate with the concentration of OH species in the fibre, indicating that OH formation is not necessarily a requirement for enhancing the photosensitivity of a photosensitive material.

In accordance with a first aspect of the present invention, there is provided a method of creating an optical structure within a selected region of a photosensitive light transmissive material, the method comprising the steps of:

hydrogen loading the selected region of the material whilst maintaining the selected region substantially at a predetermined temperature for a predetermined period of time; followed by, before exposure to any refractive index changing radiation,

removing substantially all unreacted loaded hydrogen from the selected region; followed by

exposing at least one portion of the selected region to UV radiation at a level sufficient to change the refractive index of the material within the selected region to form the optical structure;

wherein the predetermined temperature and the predetermined period of time are selected to enhance the photosensitivity of the selected region and to substantially avoid formation of hydroxyl species in the selected region during the hydrogen loading step.

The hydrogen loading may be carried out at a hydrogen pressure of at least 100 atmospheres (atm) of substantially pure hydrogen, preferably at least 200 atm of substantially pure hydrogen. In one embodiment, the hydrogen pressure during loading is substantially 500 atm, and in another embodiment the hydrogen pressure is substantially 1000 atm.

The unreacted loaded hydrogen is conveniently removed by allowing it to out-diffuse from the selected region preferably, the predetermined temperature is less than 1000° C. However, the predetermined temperature is preferably above room temperature in order to speed up the reaction time. In one embodiment, the predetermined temperature is 80° C. In another embodiment, the predetermined temperature is greater than 100° C. and less than 500° C.

Preferably, the predetermined period of time is greater than the time required for saturation of hydrogen in the material by diffusion at the selected hydrogen pressure and predetermined temperature. The predetermined period of time will depend on the predetermined temperature, the selected hydrogen pressure and the type of material. However, the predetermined time may be shortened when higher hydrogen pressures and higher temperatures are used. For a phosphosilicate glass fibre loaded with hydrogen at a pressure of 200 atm and a temperature of 80° C., the predetermined time may be approximately 14 days.

In one embodiment, the step of hydrogen loading the material includes the step of heating the hydrogen loaded into the material using microwave radiation.

In one embodiment, the selected region comprises an intended optical grating region and the step of exposing the at least one portion of the selected region to the UV radiation comprises exposing regions within the grating region to create an optical grating structure within the region. For example, the optical grating structure may be a Bragg grating.

The photosensitive light transmissive material may be in the form of a waveguide such as an optical fibre or a planar optical waveguide. The selected region may comprise the core of the fibre, or the core plus cladding. The selected region may extend along the entire length of the fibre, or it may extend along a limited section of the fibre. An entire reel of fibre may be sensitised.

The selected region may include at least one radiation-absorbing region which is doped with a radiation-absorbing medium selected to undergo heating when exposed to a predetermined wavelength of electromagnetic radiation. Incorporating such a medium in the optically-transmissive material enables localised heating of the at least one radiation-absorbing region. For example, the at least one radiation-absorbing region may comprise a core of an optical fibre in which in the radiation-absorbing medium comprises a rare-earth dopant.

Where the optically-transmissive material is in the form of an optical fibre, the fibre preferably comprises a phosphosilicate fibre. However, fibres containing other types of dopants, such as germanium oxide, can also be used.

In accordance with a second aspect of the present invention, there is provided method of enhancing the photosensitivity of a selected region of a photosensitive light transmissive material, the method comprising:

hydrogen loading the selected region whilst simultaneously maintaining the selected region substantially at a predetermined temperature for a predetermined period of time; followed by, before exposure to any refracture index changing radiation

removing substantially all unreacted loaded hydrogen from the selected region;

wherein the predetermined temperature and the predetermined period of time are selected to enhance the photosensitivity of the selected region and to substantially avoid formation of hydroxyl species in the selected region.

In accordance with a third aspect of the present, invention, there is provided an optical structure formed in a photosensitive light transmissive material by the method described in the first aspect of the present invention.

In accordance with a fourth aspect of the present invention, there is provided a photosensitive light transmissive material having an enhanced photosensitivity achieved by the method described in the second aspect of the present invention.

The invention will now be described, by way of example only, with reference to the accompanying drawings, in which:

### BRIEF DESCRIPTION OF THE DRAWINGS

FIGS. 1a to 1c are diagrammatic representations of a thermal sensitisation process in accordance with an embodiment of the present invention;

FIGS. 2 and 3 are plots of index modulation evolution and average index evolution versus fluence for an optical fibre constructed in accordance with the embodiment of FIG. 1;

FIG. 4 is a plot showing decay at room temperature of grating strength for an optical fibre having gratings produced without presensitisation;

FIG. 5 is a plot showing decay of grating strength due to thermal annealing at various temperatures for an optical fibre constructed in accordance with a prior art technique and for an optical fibre constructed in accordance with the embodiment of FIG. 1; and

FIG. 6 is a plot showing absorption profiles for a pristine optical fibre, an optical fibre after thermal sensitisation, and a thermally sensitised optical fibre after grating writing.

### DETAILED DESCRIPTION OF THE PREFERRED EMBODIMENTS

### EXAMPLE

### Thermal Sensitisation and Subsequent Grating Writing with 193 nm

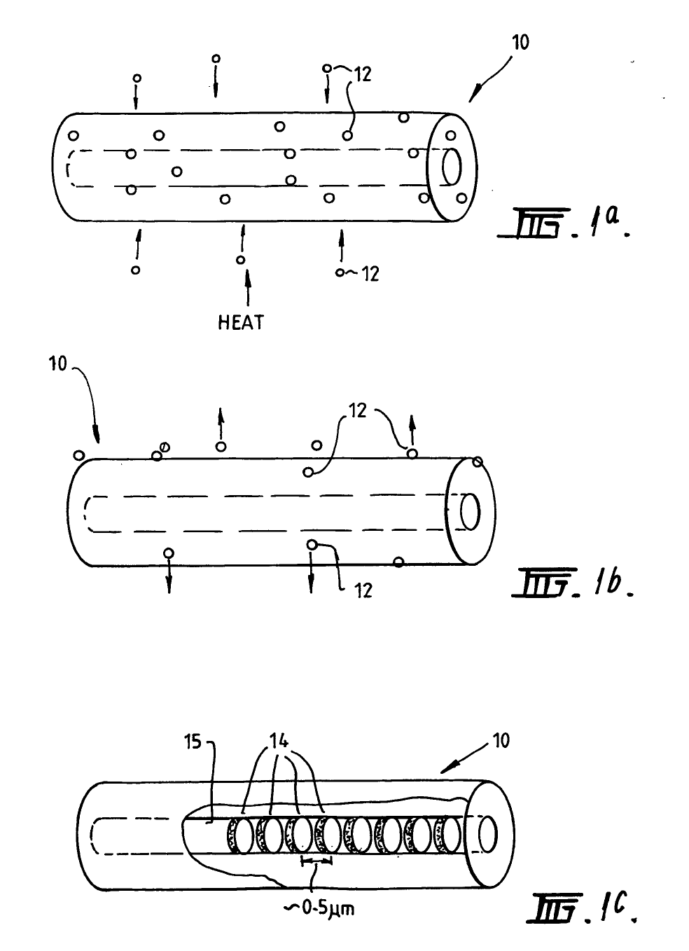

The procedure for sensitising a fibre 10 is outlined in FIG. 1. The fibre 10 in this embodiment is formed of phosphosilicate material (45 cm, 17 mol % P₂O₅). The fibre 10 in this example is also dual-moded so that photosensitivity changes in the core and at the core/cladding interface can be compared. However, it will be understood that the method is equally applicable to single-moded fibres.

The fibre 10 was loaded with hydrogen 12 at a temperature of 80° C. and pressure of 200 atm for 14 days, which is well beyond the diffusion saturation time normally required under these temperature and pressure conditions. It will be understood that any appropriate mechanism may be used to heat the optical fibre. For example, microwaves may be used to heat the hydrogen which is loaded into the optical fibre.

The fibre 10 was then left to stand at room temperature for a further 18 days to allow complete out-diffusion of the remaining free-hydrogen, as shown in FIG. 1b. One centimetre gratings 14 were then written into the core 115 at a total cumulative fluence of ˜82 kJ/cm² by scanning a 193 nm beam from an ArF laser source over one or more passes, as shown in FIG. 1c. This wavelength was chosen since it has been shown to be efficient in writing gratings, whilst maintaining low hydroxyl formation in the material.

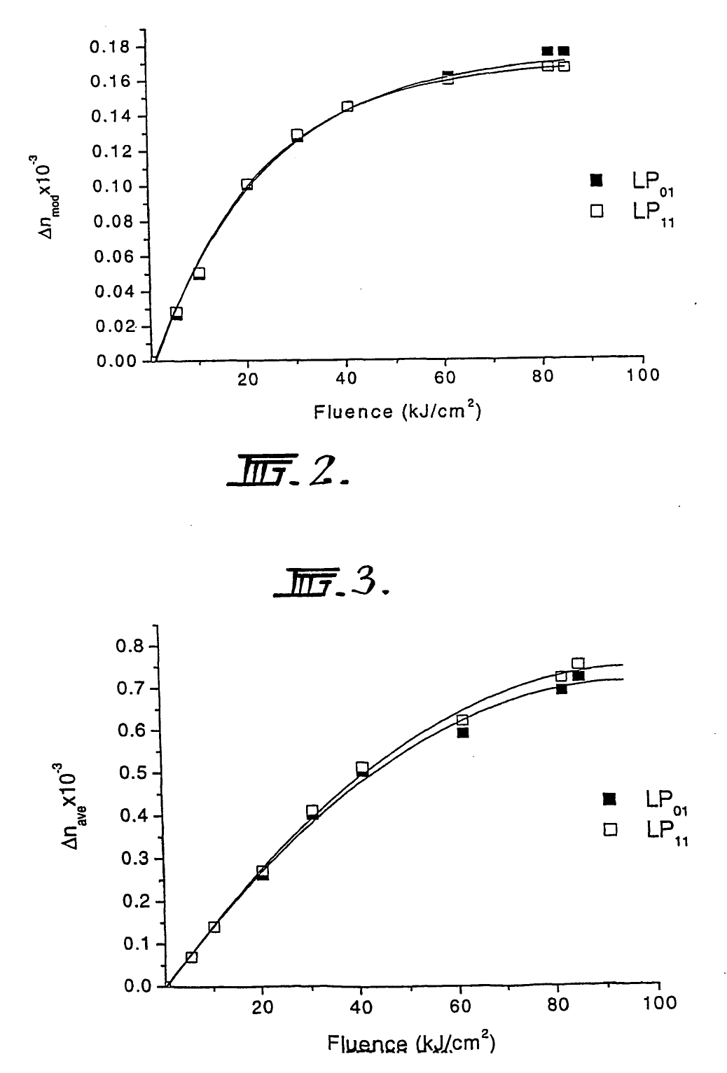

For reference, gratings were also written into a second fibre which was not presensitised. The growth profiles for both index modulation and average index are shown in FIGS. 2 and 3. The index modulation fits with a single exponential and the average index fits with an exponent which is less than one and approaches that of a linear fit.

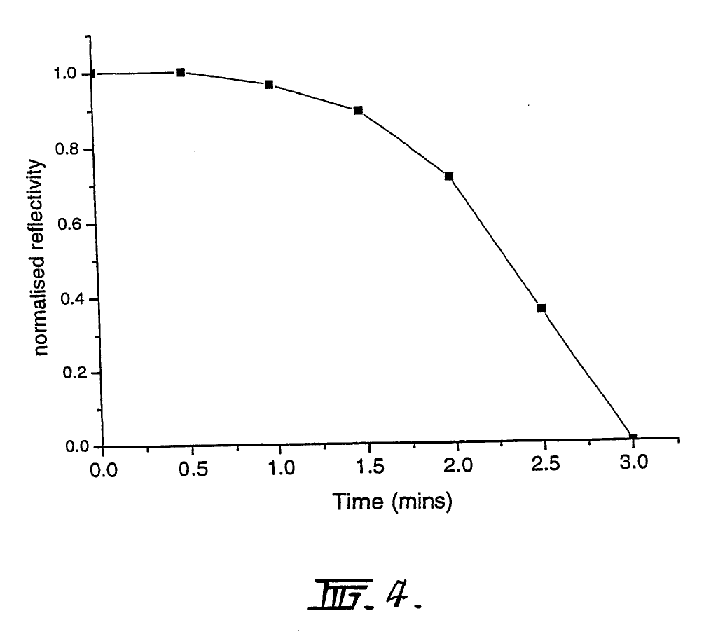

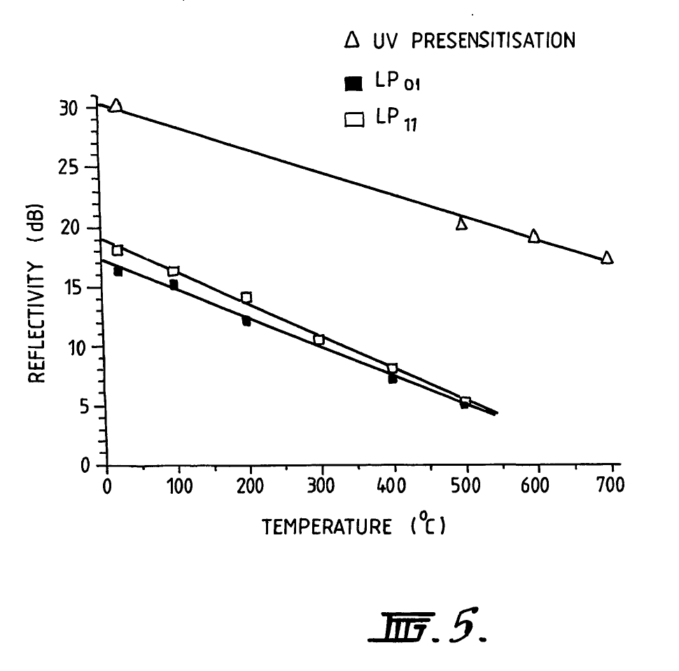

Without sensitisation, the maximum grating strength achieved is 3 dB and the decay profile is of the order of several minutes only, as shown in FIG. 4. With thermal sensitisation, the decay profile is stabilised significantly, FIG. 5 showing data for a presensitised optical fibre subjected to thermal annealing at selected temperatures for 30 minutes. It can been seen that the core index change observed for the LP₀₁ mode is slightly more stable than the cladding index change observed for the LP₁₁ mode. This indicates that there is a contribution to the index change from the core/cladding interface.

The fact that the LP₁₁ mode probes a stronger grating modulation indicates that the grating index change does not extend uniformly across the core. This is believed to be due to a reduction in index profile of the fibre at the centre of the fibre due to substantial boiloff during fabrication, with the index change following the P₂O₅ concentration.

For comparison purposes, FIG. 5 also includes a corresponding plot of reflectivity verses annealing temperature for an optical fibre presensitised using UV light. Comparable results are obtained.

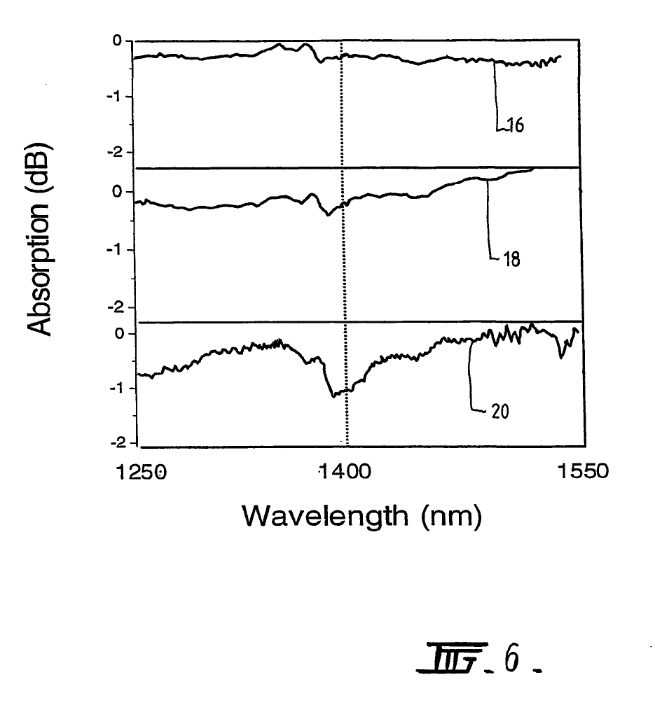

In FIG. 6, absorption profiles are shown for an optical fibre prior to thermal sensitisation 16, after thermal sensitisation 18 and after grating writing 20.

As can be seen by the absorption profile for the pristine fibre 16 and the fibre after thermal sensitisation 18, the hydrogen-loading step does not itself induce noticeable attenuation due to presence of hydroxyls. In contrast, as shown in the absorption profile for the fibre after grating writing 20, a band corresponding to Si—)H at approximately 1397 nm is present which indicates that hydrogen is being released during grating writing. The band at approximately 1.55 μm is believed to correspond to P—OH or Si—H since it is relatively narrow.

It will be appreciated that although absorption due to hydroxyls still occurs in an optical fibre constructed in accordance with the present invention, the hydroxyl formation is less compared to gratings produced by the prior art techniques of hydrogen-loading and heating to very high temperature, and presensitisation using hydrogen-loading and UV light.

It will also be appreciated that instead of carrying out the presensitisation step at a temperature of approximately 80° C. for 14 days, a higher temperature could be used together with a lower time period, or a lower temperature could be used together with a greater time period. For example, a temperature which is higher than 80° C. but less than 1000° C. may be used with a relatively short time period. However, the chosen temperature will preferably be less than 100° C.

The above example concerns sensitisation of a fibre of phosphorus silicate material. The present invention is not limited to sensitisation of phosphorus silicate fibres, but can be applied fibres and waveguides for other materials, for example, germano silicate. In the case of germano silicate, it is believed that a suitable temperature for sensitisation would be between 300° C. and 400° C., preferably 320° C.

It will be appreciated by a person skilled in the art that numerous variations and/or modifications may be made to the present invention as shown in the specific embodiment without departing from the spirit or scope of the invention as above described. The present embodiment is, therefore, to be considered in all respects to be illustrative and not restrictive.

1. A method of creating an optical structure within a selected region of a photosensitive light transmissive material, the method comprising the steps of:
hydrogen loading the selected region of the material whilst maintaining the selected region substantially at a predetermined temperature for a predetermined period of time; followed by, before exposure to any refractive index changing radiation
removing substantially all unreacted loaded hydrogen from the selected region; followed by
exposing at least one portion of the selected region to UV radiation at a level sufficient to change the refractive index of the material within the selected region to form the optical structure;
wherein the predetermined temperature and the predetermined period of time are selected to enhance the photosensitivity of the selected region and to substantially avoid formation of hydroxyl species in the selected region during the hydrogen loading step.

2. The method according to claim 1, wherein the predetermined temperature is less than 1000° C.

3. The method according to claim 1, wherein the predetermined temperature is greater than 22° C. and less than 500° C.

4. The method according to claim 3, wherein the predetermined temperature is substantially 80° C.

5. The method according to claim 1, wherein the predetermined period of time is greater than the time required for diffusion-saturation of hydrogen in the material.

6. The method according to claim 6, wherein the predetermined period of time is substantially 14 days.

7. The method according to claim 1, wherein the hydrogen loading is carried out at a pressure of at least 200 atmospheres of hydrogen.

8. The method according to claim 1, wherein the step of hydrogen-loading includes a step of heating the hydrogen loaded into the material using microwave radiation.

9. The method according to claim 1, wherein the selected region includes at least one radiation-absorbing region which is doped with a radiation-absorbing medium selected to undergo heating when exposed to a predetermined wavelength of electromagnetic radiation.

10. The method according to claim 9 wherein the radiation-absorbing medium comprises atoms of at least one rare-earth element.

11. The method according to claim 9, wherein the radiation-absorbing region comprises a core of a waveguide.

12. The method according to claim 1, wherein the selected region includes an intended optical grating region and the step of exposing the at least one portion of the selected region to the UV radiation comprises exposing regions within the grating region to create an optical grating structure within the region.

13. The method according to claim 1, wherein the photosensitive light transmissive material is in the form of an optical fibre.

14. An optical structure formed in a photosensitive light transmissive material in accordance with the method as defined in any one of the preceding claims.

15. A method of enhancing the photosensitivity of a selected region of a photosensitive light transmissive material, the method comprising:
hydrogen loading the selected region whilst simultaneously maintaining the selected region substantially at a predetermined temperature for a predetermined period of time; followed by, before exposure to any refracture index changing radiation
removing substantially all unreacted loaded hydrogen from the selected region;
wherein the predetermined temperature and the predetermined period of time are selected to enhance the photosensitivity of the selected region and to substantially avoid formation of hydroxyl species in the selected region.

16. A photosensitive light transmissive material having an enhanced photosensitivity achieved by the method as defined in claim 15.
